(19) United States
(12) Patent Application Publication
(10) Pub. No.: US 2016/0123308 A1
(43) Pub. Date: May 5, 2016

(54) GRAVITATIONAL ENERGY SYSTEM

(71) Applicant: Joe Raymond SOLOMAN, JR., Stockton, MO (US)

(72) Inventor: Joe Raymond SOLOMAN, JR., Stockton, MO (US)

(21) Appl. No.: 14/529,218

(22) Filed: Oct. 31, 2014

(51) Int. Cl. F03G 3/00; F15B 21/14; F15B 1/04

(52) U.S. Cl. CPC F03G 3/00; F15B 1/04; F15B 21/14; F15B 2201/00

(57) ABSTRACT

A gravitational energy system for generating gravity-driven hydraulic pressure for residential and commercial energy use is provided. The gravitational energy system may be a hydraulic fluid-filled circulatory system providing a storage tank, a mass-lifting tank, a hydraulic accumulator tank and at least one hydraulic motor positioned in a descending gravitational hierarchy, respectively. The hydraulic accumulator tank may pressurize a hydraulic fluid by a predetermined mass moving from a receiving position to a pressurizing position, wherein the predetermine mass is moved to the receiving position by being operably engaged with the mass-lifting tank. The gravitational energy system may include a control circuitry configured to control the flow of the hydraulic fluid through the circulatory system by operating electronically interconnected sensors and conduit valves.

### BACKGROUND OF THE INVENTION

The present invention relates to energy generation and, more particularly, to a system and method for providing gravity-driven energy for residential and commercial use.

By their very nature, current renewable energy sources such as wind and solar are intermittent and thus unreliable. As a result, current renewable energy sources are impractical as a sole source of energy for residential and commercial use.

As can be seen, there is a need for a practical system and method of generating energy driven by omnipresent source—gravitational force.

### SUMMARY OF THE INVENTION

In one aspect of the present invention, a gravity-driven circulatory system for providing energy as pressurized hydraulic fluid, comprises: a plurality of tanks for receiving a hydraulic fluid, wherein each tank is connected in series in a descending gravitational hierarchy comprising: a storage tank; a mass-lifting tank, wherein the mass-lifting tank is disposed downwardly of and connected to the storage tank, wherein the mass-lifting tank is independently mounted so as to be vertically moveable in a empty position and in a full position relative to the amount of the hydraulic fluid in its cavity; and a hydraulic accumulator tank, wherein the hydraulic accumulator tank is disposed downwardly of and connected to the mass-lifting tank; and an actuated valve interconnecting each tank of the plurality of tanks in the descending gravitational hierarchy, wherein each actuated valve is positionable in an open position and a closed position; at least one hydraulic motor, wherein the at least one hydraulic motor is disposed downwardly of and operably connected to the hydraulic accumulator tank; an air intake valve disposed on an upper portion of the hydraulic accumulator tank; a lifting mass assembly extending between the mass-lifting tank and the hydraulic accumulator tank, wherein the lifting mass assembly comprises: a predetermined mass disposed within the hydraulic accumulator tank, wherein the predetermined mass is positionable in a receiving position for receiving the hydraulic fluid into the hydraulic accumulator tank and a pressurizing position for pressurizing the hydraulic fluid disposed within the hydraulic accumulator tank; a chain and pulley system operably interconnected to the predetermined mass and the mass-lifting tank so that when the mass-lifting tank moves toward the full position the predetermined mass moves to the receiving position, and vice versa; and a locking mechanism positionable in an unlocked position and in a locked position for retaining the predetermined mass in the receiving position; and a fourth conduit interconnecting the at least one hydraulic motor and the storage tank.

In one aspect of the present invention, the gravity-driven circulatory system further comprises: a fluid sensor disposed in each tank, wherein the fluid sensor is configured to determine a volume of the hydraulic fluid within each tank; a control circuitry electronically connected to each fluid sensor, wherein the control circuitry is electro-mechanically connected to each actuated valve and the locking system, and wherein the control circuitry comprises machine-readable program code for causing, when executed, the computer to perform the following process steps: receiving input from each sensor; positioning the locking mechanism based in part on the input of each sensor; and positioning each actuated value based in part on the input of each sensor.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention, showing a first stage;

FIG. 2 is a schematic view of an exemplary embodiment of the present invention, showing a second stage;

FIG. 3 is a schematic view of an exemplary embodiment of the present invention, showing a third stage; and

FIG. 4 is a schematic view of an exemplary embodiment of the present invention, showing a fourth stage.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a gravitational energy system for generating gravity-driven hydraulic pressure for residential and commercial energy use. The gravitational energy system may be a hydraulic fluid-filled circulatory system providing a storage tank, a mass-lifting tank, a hydraulic accumulator tank and at least one hydraulic motor positioned in a descending gravitational hierarchy, respectively. The hydraulic accumulator tank may pressurize a hydraulic fluid by a predetermined mass moving from a receiving position to a pressurizing position, wherein the predetermine mass is moved to the receiving position by being operably engaged with the mass-lifting tank. The gravitational energy system may include a control circuitry configured to control the flow of the hydraulic fluid through the circulatory system by operating electronically interconnected sensors and conduit valves.

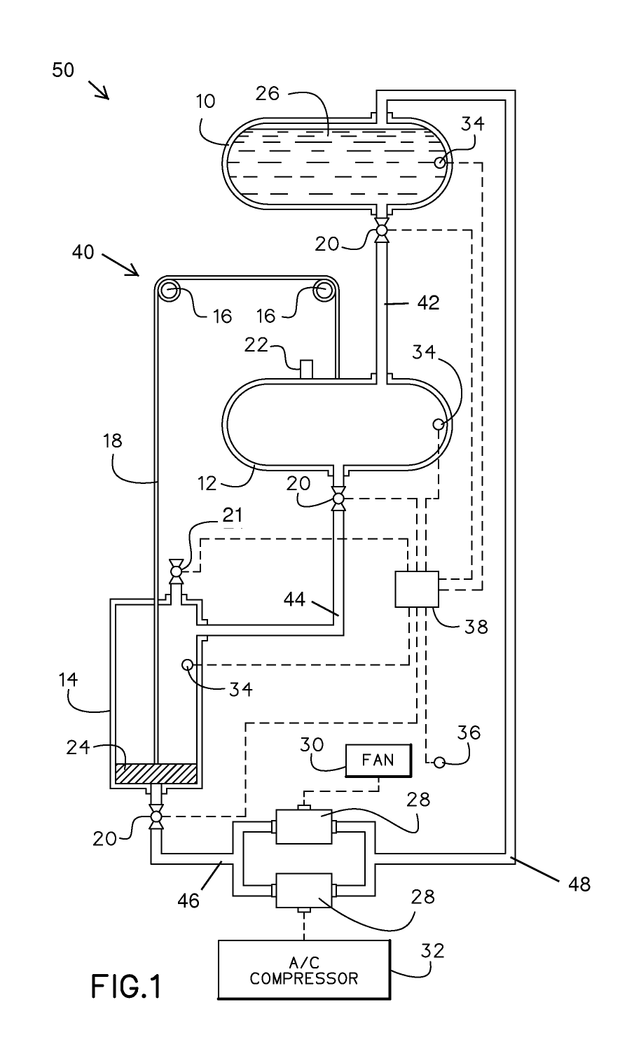

FIGS. 1 through 4 illustrate a gravitational energy system 50 embodying the method of the present invention for generating gravity-driven hydraulic pressure for residential and commercial energy use. The gravitational energy system 50 may be a circulatory system providing a storage tank 10, a mass-lifting tank 12, a hydraulic accumulator tank 14 and at least one hydraulic motor 28 positioned in a descending gravitational hierarchy, respectively. In certain embodiments, the gravitational energy system 50 may include a control circuitry 38, wherein the control circuitry 38 controls the flow of a hydraulic fluid 26 through the circulatory system by operating electronically interconnected sensors and conduit valves.

The gravitational energy system 50 may be a hydraulic fluid 26 filled circulatory system providing the storage tank 10, the mass-lifting tank 12, the hydraulic accumulator tank 14 and at least one hydraulic motor 28 positioned in a descending gravitational hierarchy, respectively, as illustrated in FIG. 1. Wherein the storage tank 10 may be positioned upwardly of and connected to the mass-lifting tank 12 by a first conduit 42, which in turn may be positioned upwardly of and connected to the hydraulic accumulator tank 14 by a second conduit 44, and which in turn is positioned upwardly of and connected to the at least one hydraulic motor 28 by a third conduit 46, which in turn is positioned downwardly of and connected to back up to the storage tank 10 by a fourth conduit 48. Each tank forms a cavity for receiving the hydraulic fluid 26.

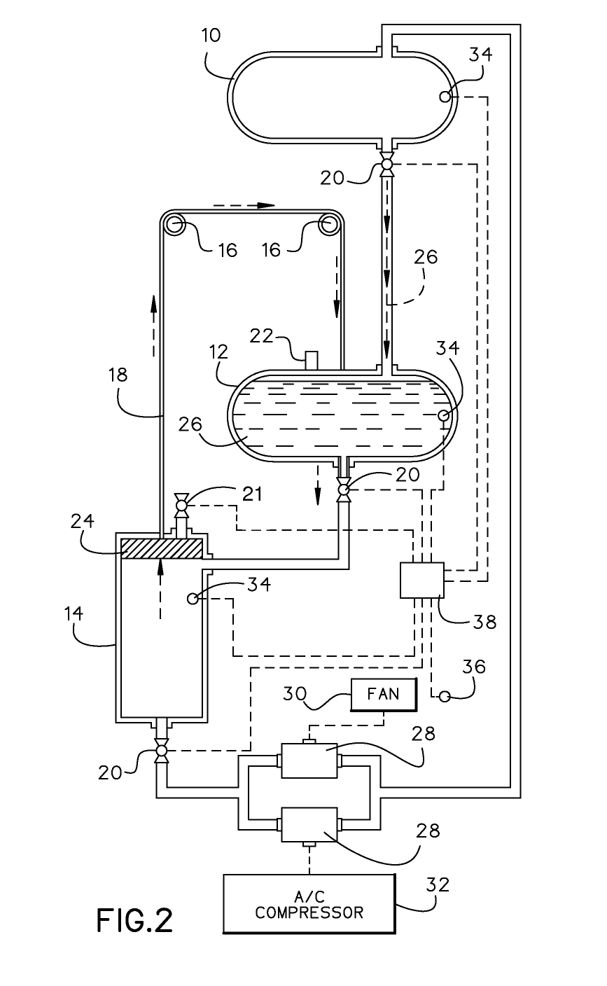

The mass-lifting tank 12 may be slidably mounted to a vertical support (not shown) so that the mass-lifting tank 12 vertically moves from an empty position downwardly to a full position as its cavity receives the hydraulic fluid 26, as illustrated in FIG. 2. The mass-lifting tank 12 may be adapted to move back upwardly to the empty position as the hydraulic fluid 26 flows therefrom. Accordingly, the mass-lifting tank 12 may be movably interconnected to the first conduit 42 and the second conduit 44. The first conduit 42 and the second conduit 44 may be adapted to be move in a retracted position and in an extended position so that as the mass-lifting tank 12 vertically moves the first conduit 42 and the second conduit 44 move to their corresponding positions, as illustrated in FIG. 2.

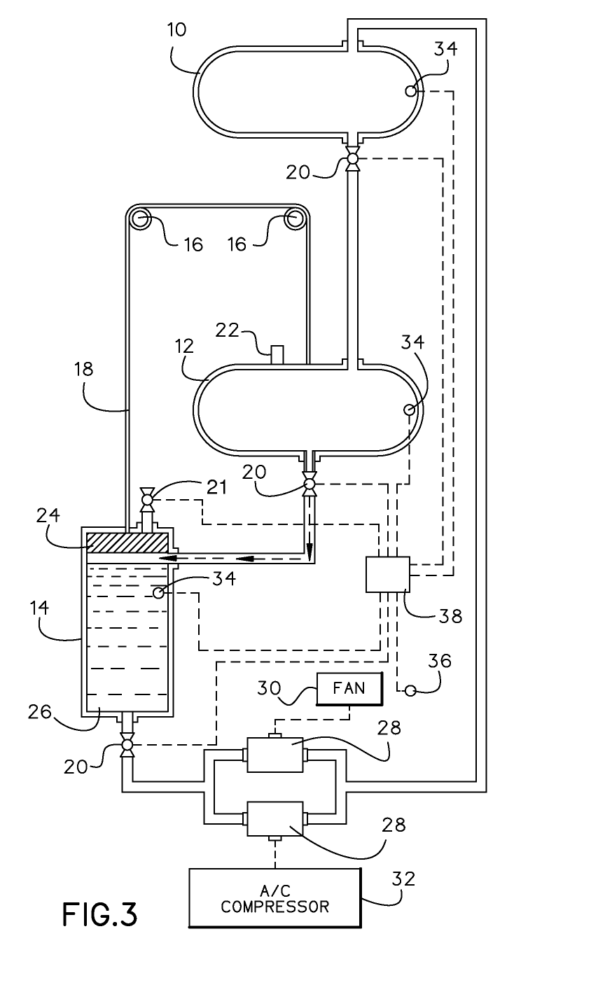

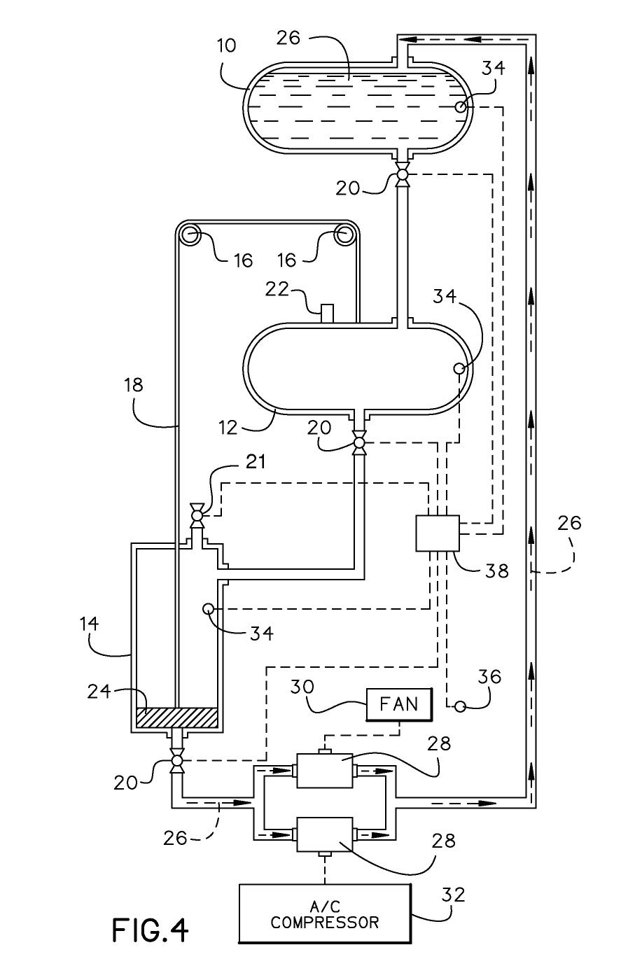

The mass-lifting tank 12 may be operably engaged with a lifting mass assembly 40 so that a predetermined mass 24 moves along vertical path opposing the vertical movement of the mass-lifting tank 12 from the empty position to the full position. The predetermined mass 24 may be disposed within the hydraulic accumulator tank 14 so as to move from a pressurizing position to a receiving position, as illustrated FIG. 2. The lifting mass assembly 40 may include the predetermined mass 24 connected to lifting system, such as a chain 18 and a pulley system 16 for providing the opposing vertical movement relative to the mass-lifting tank 12. The lifting mass assembly 40 may include a locking mechanism 22 positionable in a locked position for retaining the predetermined mass in the receiving position, as illustrated in FIG. 3, and in an unlocked position. The pressurizing position may at the gravitational bottom of the hydraulic accumulator tank 14, as illustrated in FIGS. 1 and 4. The predetermined mass 24 may be manually adjusted so as to be at least commensurate with a work routine to be performed. The predetermined mass 24 may provide a diaphragm or other seal that substantially prevents the hydraulic fluid 26 from flowing anywhere but downwardly through the third conduit 46 when the predetermined mass 24 moves to the pressurizing position. The hydraulic accumulator tank 14 may provide an air intake valve 21 for preventing a substantial vacuum from forming when the predetermined mass 24 moves to the pressurizing position, as illustrated in FIG. 4.

The third conduit 46 may be operably engaged to at least one hydraulic motor 28 adapted to be powered by the hydraulic fluid 26 flowing through the third conduit 46. The pressure of the hydraulic fluid 26 through the third conduit 46 may be proportional to the predetermined mass 24. In certain embodiments, a plurality of hydraulic motors 28 may be connected in parallel along the third conduit 46. Each hydraulic motor 28 may be adapted to convert the hydraulic pressure of the hydraulic fluid 26 into electric energy for at least one electrically connected devices, such as but not limited to, a fan 30 and/or an A/C compressor 32.

The gravitational energy system 50 may include up to four (4) sequential stages. In a first stage, the hydraulic fluid 26 may be substantially stored in the storage tank 10 with an associated actuated valve 20(10) in a closed position, as illustrated in FIG. 1.

When needed, a second stage may be initiated by moving the associated actuated valve 20(10) to an open position so that the hydraulic fluid 26 substantially flows downwardly through the first conduit 42 and into the mass-lifting tank 12, moving the mass-lifting tank 12 downwardly toward the full position, as illustrated in FIG. 2.

A third stage may be initiated by moving the associated actuated valve 20(12) of the mass-lifting tank 12 to an open position so that the hydraulic fluid 26 substantially flows downwardly through the second conduit 44 and into the hydraulic accumulator tank 14, wherein the predetermined mass 24 is locked in the receiving position by the locking mechanism 22, as illustrated in FIG. 3.

A fourth stage may be initiated by moving the actuated valve 20(14) associated with the hydraulic accumulator tank 14 to an open position in concert with the unlocking of the locking mechanism 22 so that the hydraulic fluid 26 substantially flows under the downward pressure of the predetermined mass 24 moving to the pressurizing position. The increasingly pressurized hydraulic fluid 26 may be urged downwardly through the third conduit 46 and through the at least one hydraulic motors 28, as illustrated in FIG. 4. The fourth stage replenishes the storage tank 12 with hydraulic fluid 26 flowing through the fourth conduit 48 when the associated actuated valve 20(10) is in the closed position.

As a result of the circulatory nature of the flow of the hydraulic fluid 26, the system 50 is self-replenishing and thus has a substantially perpetual cycle.

Each actuated valve 20 for controlling the flow of the hydraulic fluid 26 through its associate conduit may be electro-mechanically connected to the control circuitry 38. The control circuitry 38 may be electrically connected to a sensor 34 disposed within each tank. Each sensor 34 may be configured to determine the volume of the hydraulic fluid 26 within each tank. The control circuitry 38 may also be electrically connected to a thermostat 36, the locking mechanism 22 and the air intake value 21. The control circuitry 38 may require a small amount of electricity to operate.

The control circuitry 38 may include at least one computer with a user interface for automating the gravitational energy system 50 so that the respective actuated valves 20, the locking mechanism 22 and the air intake value 21 are in their proper positions relative to the location of the hydraulic fluid 26 in the gravitational energy system 50 moving through the sequential four stages. The computer may include at least one processor connected to a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The method of using the present invention may include the following. The gravitational energy system 50 disclosed above may be provided. A user may mount to the lifting mass assembly 40 the predetermined mass 24 that is at least commensurate with the work routine to be performed. The user may manually operating the plurality of actuated valves 20, the locking mechanism 22 and the air intake value 21 as the gravitational energy system 50 cycles through the sequential four stages. In an alternative embodiment, the user may configure the control circuitry 39 to manually operate the gravitational energy system 50 in such respect. In certain embodiments, a plurality of gravitational energy system 50 may be provided in tandem to provide persistent work to the at least one electrically connected devices.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention

It should be understood, of course, that the foregoing relates to exemplary embodiments of the invention and that modifications may be made without departing from the spirit and scope of the invention as set forth in the following claims.

What is claimed is:

1. A gravity-driven circulatory system for providing energy as pressurized hydraulic fluid, comprising:
a plurality of tanks for receiving a hydraulic fluid, wherein each tank is connected in series in a descending gravitational hierarchy comprising:
a storage tank;
a mass-lifting tank, wherein the mass-lifting tank is disposed downwardly of and connected to the storage tank, wherein the mass-lifting tank is independently mounted so as to be vertically moveable in a empty position and in a full position relative to the amount of the hydraulic fluid in its cavity; and
a hydraulic accumulator tank, wherein the hydraulic accumulator tank is disposed downwardly of and connected to the mass-lifting tank; and
a lifting mass assembly extending between the mass-lifting tank and the hydraulic accumulator tank, wherein the lifting mass assembly comprises:
a predetermined mass disposed within the hydraulic accumulator tank, wherein the predetermined mass is positionable in a receiving position for receiving the hydraulic fluid into the hydraulic accumulator tank and a pressurizing position for pressurizing the hydraulic fluid disposed within the hydraulic accumulator tank; and
a chain and pulley system operably interconnected to the predetermined mass and the mass-lifting tank so that when the mass-lifting tank moves toward the full position the predetermined mass moves to the receiving position, and vice versa; and
a fourth conduit interconnecting the hydraulic accumulator tank and the storage tank.

2. The gravity-driven circulatory system of claim 1, further including at least one hydraulic motor, wherein the at least one hydraulic motor is disposed downwardly of and operably connected to the hydraulic accumulator tank, and wherein the fourth conduit interconnects the at least one hydraulic motor and the storage tank.

3. The gravity-driven circulatory system of claim 1, further including an air intake valve disposed on an upper portion of the hydraulic accumulator tank.

4. The gravity-driven circulatory system of claim 1, wherein the lifting mass assembly further comprises a locking mechanism positionable in an unlocked position and in a locked position for retaining the predetermined mass in the receiving position.

5. The gravity-driven circulatory system of claim 4, further including an actuated valve interconnecting each tank of the plurality of tanks in the descending gravitational hierarchy, wherein each actuated valve is positionable in an open position and a closed position.

6. The gravity-driven circulatory system of claim 5, further including:
a fluid sensor disposed in each tank, wherein the fluid sensor is configured to determine a volume of the hydraulic fluid within each tank;
a control circuitry electronically connected to each fluid sensor, wherein the control circuitry is electro-mechanically connected to each actuated valve and the locking system, and wherein the control circuitry comprises machine-readable program code for causing, when executed, the computer to perform the following process steps:
receiving input from each sensor;
positioning the locking mechanism based in part on the input of each sensor; and
positioning each actuated value based in part on the input of each sensor.

7. The gravity-driven circulatory system of claim 6, further including the hydraulic fluid.

8. A gravity-driven circulatory system for providing energy as pressurized hydraulic fluid, comprising:
a plurality of tanks for receiving a hydraulic fluid, wherein each tank is connected in series in a descending gravitational hierarchy comprising:
a storage tank;
a mass-lifting tank, wherein the mass-lifting tank is disposed downwardly of and connected to the storage tank, wherein the mass-lifting tank is independently mounted so as to be vertically moveable in a empty position and in a full position relative to the amount of the hydraulic fluid in its cavity; and
a hydraulic accumulator tank, wherein the hydraulic accumulator tank is disposed downwardly of and connected to the mass-lifting tank; and
an actuated valve interconnecting each tank of the plurality of tanks in the descending gravitational hierarchy, wherein each actuated valve is positionable in an open position and a closed position;
at least one hydraulic motor, wherein the at least one hydraulic motor is disposed downwardly of and operably connected to the hydraulic accumulator tank;
an air intake valve disposed on an upper portion of the hydraulic accumulator tank;
a lifting mass assembly extending between the mass-lifting tank and the hydraulic accumulator tank, wherein the lifting mass assembly comprises:
a predetermined mass disposed within the hydraulic accumulator tank, wherein the predetermined mass is positionable in a receiving position for receiving the hydraulic fluid into the hydraulic accumulator tank and a pressurizing position for pressurizing the hydraulic fluid disposed within the hydraulic accumulator tank;
a chain and pulley system operably interconnected to the predetermined mass and the mass-lifting tank so that when the mass-lifting tank moves toward the full position the predetermined mass moves to the receiving position, and vice versa; and
a locking mechanism positionable in an unlocked position and in a locked position for retaining the predetermined mass in the receiving position; and
a fourth conduit interconnecting the at least one hydraulic motor and the storage tank.

9. The gravity-driven circulatory system of claim 8, further including:
a fluid sensor disposed in each tank, wherein the fluid sensor is configured to determine a volume of the hydraulic fluid within each tank;
a control circuitry electronically connected to each fluid sensor, wherein the control circuitry is electro-mechanically connected to each actuated valve and the locking system, and wherein the control circuitry comprises machine-readable program code for causing, when executed, the computer to perform the following process steps:
receiving input from each sensor;
positioning the locking mechanism based in part on the input of each sensor; and
positioning each actuated value based in part on the input of each sensor.

10. The gravity-driven circulatory system of claim 8, further including the hydraulic fluid.
